(19) United States
(12) Patent Application Publication
(10) Pub. No.: US 2026/0218523 A1
(43) Pub. Date: Jul. 30, 2026

(54) A PANEL AND A METHOD FOR PRODUCING PANELS

(71) Applicant: UNILIN, BV, Wielsbeke (BE)

(72) Inventors: Bruno VERMEULEN, Wielsbeke (BE); Koen NEL, Wielsbeke (BE); Wiebe VAN GANSBEKE, Wielsbeke (BE); Samuel KRAMÁR, Wielsbeke (BE)

(21) Appl. No.: 19/146,113

(22) PCT Filed: Feb. 6, 2024
(86) PCT No.: PCT/IB2024/051063

§ 371 Date: Jul. 7, 2025

Related U.S. Application Data
(60) Provisional application No. 63/483,571, filed on Feb. 7, 2023.
(60) Provisional application No. 63/493,330, filed on Mar. 31, 2023.

(51) Int. Cl. E04F 15/10; B32B 3/06; B32B 21/02; E04F 13/08; E04F 15/02

(52) U.S. Cl. CPC E04F 15/107; B32B 3/06; B32B 21/02; E04F 13/0866; E04F 13/0894; E04F 15/02038; B32B 2471/00; B32B 2607/00; E04F 2201/023; E04F 2201/043

(57) ABSTRACT

Panels and a method for producing such panels, where the panels include at least a layer-shaped substrate made from recycled material derived from end-of-life panels or boards. The method involves providing end-of-life panels or boards and further includes shaping these panels or boards to form the recycled material.

The present invention relates to a method for the production of panels, for example floor panels or wall panels or furniture panels, wherein said panels at least comprise recycled material from end-of-life panels or boards, and wherein the method comprises the step of providing end-of-life panels or boards.

The present invention also relates to a panel, for example a floor panel or a wall panel or a furniture panel, wherein said panel comprises at least recycled material from end-of-life panels or boards.

For environmental reasons and also because raw materials are not inexhaustible, it is important to make optimal use of end-of-life panels or boards. Preferably said end-of-life panels or boards are recycled, such that they can form recycled material that can be used to make new panels. Nowadays many processes are present to form said recycled material, the choice of process largely depending on the type of end-of-life panels or boards. With end-of-life panels can be indicated panels of the non-exhaustive list: panels that have been used by an end consumer and/or waste from production and/or waste from installation, shipping, marketing and/or unsold stock.

A known recycling process is a recycling process of particle boards and decorative panels comprising particle board, wherein said particles boards are shredded into smaller particles and form recycled wood chips that can be used to make new particle boards. The quality of these recycled wood chips is inferior to wood chips made from fresh wood and also the quality declines after every shredding process, meaning that particle boards cannot be recycled indefinably.

Wood fiber boards, such as MDF (Medium Density Fiberboard) or HDF (High Density Fiberboard) or LDF (Low Density Fiberboard), or decorative panels comprising wood fiber boards, can be recycled to form recycled wood fibers. There are different processes available to make these recycled wood fibers. Examples of processes are for example described in WO 2021/229144 and WO 2021/112749, which makes use of steaming. A disadvantage of these processes is that these processes require energy and also the quality of the produced recycled wood fibers can be inferior to the quality of newly made wood fibers.

Thermoplastic based end-of-life panels, such as LVT (luxury vinyl tile) and SPC (stone plastic composite), which comprise one or more layers with thermoplastic material as a binding material, optionally fillers and/or optionally plasticizers, can also be recycled. Said thermoplastic material makes up or does not make up at least half of the weight of a said layer. Said thermoplastic based end-of-life panels can be shredded, remelted and shaped into pellets, wherein these pellets can be used as raw material for the production of new thermoplastic panels. Remelting is energy consuming. The quality of the thermoplastic material can decline when being melted, making said recycled thermoplastic material less suitable to be used for the production of new panels.

It is therefore an object of the invention to provide an alternative method to produce panels and to provide an alternative panel comprising recycled material.

This object, according to a first aspect, is achieved by providing a method for the production of panels, wherein said panels at least comprise a layer-shaped substrate comprising recycled material from end-of-life panels or boards, wherein the method comprises the step of providing end-of-life panels or boards, and wherein the method further comprises the step of shaping said end-of-life panels or boards into plate-shaped or beam-shaped pieces by subjecting the end-of-life panels or boards to one or more of the following shaping steps: cutting, sawing, milling, pressing, performing surface treatments such as shaving, peeling or sanding, or delaminating—in case the end-of-life panels or boards are multi-layered-;
wherein said plate-shaped or beam-shaped pieces form said recycled material and wherein preferably
said recycled material forms at least half the thickness of said layer-shaped substrate, more preferably at least 70 percent and/or
said recycled material forms at least 50 percentage by weight of said layer-shaped substrate, more preferably at least 70 percentage by weight.

The invention relates to methods to make panels, this being thus newly made panels. The invention also relates to this newly made panels as such. Throughout this description, with said newly made panels, not only floor panels or wall panels or furniture panels are indicated. Also other types of newly made panels, for example building or construction panels, can be indicated.

Said end-of-life panels or boards can be chosen from the non-exhaustive following list: wood fiber boards, such as HDF (high density fiberboard), MDF (medium density fiberboard), LDF (low density fiberboard), softboard or hardboard;
particle board, OSB (oriented strand board), plywood, glulam;
flax board, hemp board, bamboo boards;
wood plastic composite board;
mineral based boards comprising for example cement or MgO;
thermoplastic based panels such as LVT and SPC and WPC (waterproof plastic composite);
polyurethane based boards;
laminate comprising a lignocellulose based substrate, such as wood fiberboard or particle board, and for example one or more resin impregnated paper layers and/or a veneer layer.
laminate comprising a mineral based substrate comprising for example cement or MgO, and for example one or more resin impregnated paper layers and/or or veneer layer
solid wood panels, engineered wood panels,
sheet vinyl flooring, rubber flooring, linoleum flooring
carpet or carpet tiles or rugs
etc.

Preferably to form said newly made panels, the same type of end-of-life panels are chosen, meaning that one type of the abovementioned non-exhaustive list is chosen.

Said shaping steps are energy efficient steps and do not require complex installations. Also the internal structure and/or composition of the end-of-life panels or boards is not or only in a small amount destroyed by said shaping steps, such that said plate-shaped or beam-shaped pieces comprise a similar structure and/or composition as parts of said end-of-life panels or boards. Said shaping steps do not cause decomposition. Said shaping steps do not or only in a little amount decrease the quality of the material of said end-of-life panels or boards. The said end-of-life panels or boards are used to form said layer-shaped substrate. Said end-of-life panels or boards have a certain strength, rigidity, softness and/or quality, such that layer-shaped substrates made from said pieces can also have the desired strength, rigidity, softness and/or quality. With one or more shaping steps, which are little invasive steps, a suitable raw material is made to make panels, such that said panels do not only comprise recycled material, but said recycled material does not add complexity and/or does not or only little contribute to the energy consumption. Said plate-shaped or beam-shaped pieces can substantially form the layer-shaped substrate, for example the layer-shaped substrate can comprise at least 90 percentage by weight of said recycled material or said recycled material can form at least 90 percentage of the thickness of the layer-shaped substrate and even said plate-shaped or beam-shaped pieces can entirely form the layer-shaped substrate. However it is also possible that the layer-shaped substrate is multilayered and said recycled material only forms one sublayer. For example said one sublayer can or cannot be more than half the thickness of the layer-shaped substrate.

For example if said end-of-life panels or boards are sheet vinyl flooring or rubber flooring or linoleum flooring or carpet or carpet tiles or rugs, which are seen as soft flooring, then said end-of-life panels or boards can be shaped, for example cut, into the plate-shaped pieces and form for example the bottom of the substrate—can act as a pad-attached—, a centrally located layer of the substrate, or the top layer of the substrate. Such plate-shaped pieces can improve sound and ergonomics of the newly made panel.

For example if said end-of-life panels or boards are laminate flooring or SPC flooring or parquet flooring, which are seen as rigid flooring, then said end-of-life panels or boards can be shaped into plate-shaped pieces or beam-shaped pieces which form at least half the thickness of the layer-shaped substrate and provide rigidity and strength to the newly made panels.

If said layer-shaped substrate comprises more than one layer, pieces of so-called soft flooring could be used to form a layer of said layer-shaped substrate and also pieces of so-called rigid flooring can be used to form another layer of said layer-shaped substrate.

The choice of the one or more shaping steps that are performed, depend on the type of end-of-life panels or end-of-life boards and also upon the desired type of panel. For example if the end-of-life panels comprise coupling parts, such as tongue and groove, one can remove said coupling parts, by for example cutting or sawing, to form said pieces. This will reduce the risk that newly made panels have weaker parts, for example if one wants to have newly made panels with milled coupling parts, it is important that no weak parts are present. Further dividing steps, and this after, before or during removal of the coupling parts, are possible to form beam-shaped pieces. For example for rectangular shaped newly made panels, said beam-shaped or plate-shaped pieces can be oriented in the layer-shaped substrate transverse to the longitudinal direction of the panel and this to provide additional strength to the panel. For example for rectangular shaped newly made panels, use can be made of plate-shaped beams, wherein said newly made panels have a longitudinal direction transverse to said plate-shaped beams.

Pressing can be used to create pieces with an average thickness that lies in a narrow thickness range, for example a thickness range that spans at most 0.5 mm, preferably at most 0.3 mm. Pressing could also or additionally be used to increase the strength. To create pieces with an average thickness that lie in a narrow thickness range, for example a thickness range that spans at most 0.5 mm, preferably at most 0.3 mm, one could instead of pressing or additionally, use sanding and/or shaving. If said end-of-life panels are multi-layered and only some layers, or some layers are only partly of interest, one could choose to perform surface treatments such as shaving, peeling or sanding and/or one could remove a layer by cutting and/or sawing and/or milling and/or delaminating. For example if the end-of-life panels comprise a substrate and a top layer, one could remove the top layer by for example delamination and form the said pieces out of the substrate. Multiple shaping steps are possible. For example for end-of-life panels comprising coupling parts, one could first remove the coupling parts by for example cutting or sawing, then one could press and/or sand to have the desired height and strength, and optionally one could further divide according to a direction perpendicular to the end-of-life panel. Before or after pressing, one could optionally remove partly or entirely one or more layers if the end-of-life panel is a multilayered panel comprising at least one substrate and at least one additional layer directly or indirectly attached to the substrate. For example if said end-of-life panels comprise, seen from the top to the bottom, a top layer, a substrate and a balancing layer, one could choose to remove or to sand/peel/shave the balancing layer and preferably place the obtained pieces upside down and provide a decorative layer upon the sanded/peeled/shaved balancing layer or the substrate, to form newly made panels. Since balancing layers normally do not comprise hard particles, for example corundum or aluminum oxide, sanding/peeling/shaving can easily take place. Further it has been found that sanded/peeled/shaved balancing layers are very suitable to laminate additional layers, such as resin impregnated papers, upon it.

Said pieces can entirely form the layer-shaped substrate of the said panels. For example if the end-of-life panel is a laminate comprising a lignocellulose based substrate, such as MDF, HDF or particle board, or if the end-of-life board is a lignocellulose based board, then said pieces can be entirely made out of said lignocellulose based substrate or said end-of-life panel, by performing one or more of the above shaping actions. For example if the end-of-life panel is a laminate with a substrate and a top layer, said top layer can be removed by a said shaping step to form a plate-shape piece. However, it is also possible to keep the top layer when forming a said plate-shaped piece. For example if the end-of-life panel is laminate comprising from the top to the bottom a top layer, a substrate and a balancing layer, one could choose only the remove the balancing layer or to sand the balancing layer and remain the top layer, when forming said plate-shaped or beam-shaped pieces. It can be more difficult to remove or sand the top layer when said top layer comprises wear resistant particles such as aluminum oxide or corundum.

In a very preferred embodiment, to form said panels,
a said piece forms a plate-shaped board or two or more of said pieces form said plate-shaped board. Said pieces are plate-shaped or beam-shaped. If a said piece is plate-shaped, it is suitable to form said plate-shape board as such. Multiple pieces can be placed adjacent to each other and according to one plane to form said plate-shaped board. Preferably said pieces are attached to each other and this with or without the aid of an additional glue. For example if the end-of-life panels or boards comprises lignocellulose material such as wood fibers or wood chips, one can choose for a glue to attach the pieces to each other and/or specific joints such as fingerjoints or dovetail joints or box joints or tongue and groove joints or butt joints or lap joints or miter joints. Said specific joints can for example be milled. If however the end-of-life panels or boards are thermoplastic based panels or boards, meaning that a thermoplastic material is used as a binder material, for example if said end-of-life panels or boards are SPC, LVT or WPC or wood plastic composite, one does not need to use an additional glue, one could melt the pieces together at the height of their adjacent edges. Said melting can take place in a mold and/or heat could be added. Of course also an additional glue and/or specific joints such as fingerjoints or dovetail joints or box joints or tongue and groove joints or butt joints or lap joints or miter joints, could be used. Said plate-shaped board has two opposite surfaces. Said plate-shaped board can form a pad suitable to form the bottom of a newly made panel, thus the bottom of the layer-shaped substrate. Said plate-shaped board can form at least half the thickness of the layer-shaped substrate of a newly made panel. Said plate-shaped board can form a layer of the layer-shaped substrate of the newly made panel that provides ergonomic benefits, improves sound characteristics, rigidity, etc.
said plate-shaped board forms a base substrate or one or more layers are applied upon said plate-shaped board to form said base substrate. For example if one wishes to form a newly made panel, such as a laminate comprising a layer-shaped substrate, a top layer and optionally a balancing layer. One can choose for a said plate-shaped board which forms said base substrate. If multi-layered end-of-life panels are used comprising a substrate, a top layer and optionally a balancing layer and optionally a pad-attached, one can choose to remove or not to remove at least part of said top layer and/or said balancing layer and/or said pad-attached to form said pieces, such that said newly made panels comprise a layer-shaped substrate at least partly similar to the substrate of the used end-of-life panel. Said additional layers could for example be one or more levelling layers, comprising levelling material to provide a substrate with flat surfaces. Said additional layer could also be an MDF/HDF-layer or a particle board layer or a thermoplastic layer, wherein said plate-shaped board could for example be a more rigid layer or a more soft layer than said additional layers. In a specific embodiment, said plate-shaped or beam-shaped pieces can be applied to one or more additional layers, such that the step of forming said plate-shaped board is performed during the formation of the base substrate. For example one could attach said plate-shaped or beam-shaped pieces to an MDF/HDF-layer or a particle board layer or a thermoplastic layer, to form said base substrate. Said additional layer or layers could be used to connect, or to further connect, the said pieces to each other and to form preferably a base substrate with flat surface.
said base substrate forms a base plate, or a decorative base layer and/or a balancing base layer is applied upon said base substrate to form said base plate. Said decorative base layer and/or a balancing base layer can be directly applied without an additional glue or glue layer, or one could use an additional glue or glue layer. Said decorative base layer and/or a balancing base layer can or cannot be multilayered. Said base substrate has two opposite surfaces. For newly made panels only having one decorative side, such as floor panels, said decorative base layer is than applied to the said surface which will be at the top and the optionally balancing base layer is than applied to the said surface which will be at the bottom. For newly made panels having two decorative sides, such as for example furniture panels, a decorative base layer is applied to both said surfaces of the base surface. Said decorative base layer can be transparent such that the respective surface is visible.
said base plate is divided into multiple smaller base panels, or said base plate forms a base panel. If one said piece is used to form the base plate, said base plate then preferably forms the base panel. However if one wants to make panels, such as floor panels, it can be desirable to make use of multiple plate-shaped or beam-shaped pieces to form said base plate and then to divide said base plate into smaller panels. In know production methods to make panels, the method of dividing a bigger plate into smaller panels is used extensively, such that one does not need to change its entire production process;
said base panel forms the panel, or said base panel is subjected to one or more method steps, for example milling to form coupling parts and/or providing waterproof coatings/impregnation agents to the edges, to form a said panel, such that each panel comprises a layer-shaped substrate made from a said piece or made from two or more of said pieces.

Further preferably, to form said plate-shaped board, two or more of said pieces are placed next to each other, and preferably attached to each other and/or glued together, in such a way that said pieces extend next to each other according to the plane of the plate-shaped board. When said base plate is formed, pieces of said two or more pieces can have the same orientation as their original orientation in the end-of-life panels and/or they can be placed upside down in said base plate, meaning that the topside of a said piece is now the bottom side and the bottom side is now the topside. Some pieces can have the same orientation, while others are placed upside down. Preferably at least the thickness dimension or even more preferably all the dimensions of said pieces are substantially the same. With such pieces it is easy to form a plate-shaped board with flat surfaces. If end-of-life panels or board are used of the same or similar batches, for example floor panels with the same dimensions, it is easy to produce pieces of the same dimensions. They can be glued together with the aid of an additional glue. For example if said pieces comprise wood-based material such as wood fibers or wood chips, and this for example because the end-of-life panels are panels comprising MDF, HDF or particle board, one could use the same glue as used to connect this wood-based material or another glue that is also capable of connecting wood-based material. Said glue could for example be chosen from the list of: urea formaldehyde glue, melamine urea formaldehyde glue, melamine urea phenol formaldehyde glue, melamine formaldehyde glue, isocyanate glues, such as MDI (“methylene diphenyl diisocyanate”) or pMDI (“polymeric methylene diphenyl diisocyanate”), polyurethane glue or bio-based glues such as glue based upon sugar, lignin, flour, etc. Said plate-shaped or beam-shaped pieces preferably have a rectangular, for example a square or elongate, shape and can be placed against each other with their edges with the glue in between. Depending on the composition of the pieces, an additional glue is not always necessary. For example if said pieces comprise thermoplastic material that is used as a binder, for example if said pieces are obtained from thermoplastic end-of-life panels or boards, such as SPC, LVT or WPC or wood plastic composite one could place said pieces next to each other such that said pieces lie against each other—this is possible since said pieces are plate-shaped or beam-shaped—and apply heat to at least said edges such that they melt together. By applying heat and/or pressure, the thermoplastic material of adjacent pieces could connect to each other. Of course an additional glue, such as a thermoplastic glue, could be used to adhere said pieces. Also or in addition, specific joints such as fingerjoints or dovetail joints or box joints or tongue and groove joints or butt joints or lap joints or miter joints, can be used to attach the pieces to each other. These specific joints are for example formed by milling.

Further, even more preferably, said base plate is divided into multiple base panels, and this preferably at least at the height of sections where two said pieces adjoin. Here the strength of the pieces is optimally used and this because said base panels could comprise substantially a complete said piece or complete said pieces. Said base panels can then be well milled, for example to form coupling parts if desired. For example, in a specific embodiment, one or more of said shaping steps are performed on one end-of-life panel to form one said piece. Multiple of said pieces are used to form a said base plate and said base plate is divided into multiple base panels, such that each base panel, with regard to the pieces, only comprises material of one said piece. Here one end-of-life panel is used to form one new panel. Preferably said end-of-life panel forms the entire layer-shaped substrate of the said panel, or at least 50, 70 or 90 percent of the thickness of the layer-shaped substrate of the panel. In other words, to form a new panel, only a decorative layer and optionally a balancing layer needs to be adhered to an end-of-life panel, with said end-of-life panel having undergone one or more of shaping steps to form a said piece that is suitable to be used to make new panels. For example an end-of-life floor panel with coupling parts and a substrate and one or more other layers, could having undergone cutting and/or surface treatments and/or pressing to remove the coupling parts and (parts of) said other layers which are less desirable, such as layers comprising wear-resistant particles or layers that are less suitable for adherence to a new decorative layer. For example if said one or more layers comprise a veneer, one could choose to remove this veneer and optionally reuse this veneer for decorative purposes.

To have the same end result as in the abovementioned specific embodiment, one could in an alternative embodiment have a said piece that forms the plate-shaped board, wherein said plate-shaped board forms a base substrate or one or more layers are applied upon said plate-shaped board to form said base substrate. Said base substrate forms a base plate, or a decorative base layer and/or a balancing base layer is applied upon said base substrate to form said base plate. Said base plate forms the base panel.

Preferably said pieces are oblong shaped and the length directions of said pieces extend in the same direction in the plate-shaped board. Said pieces could additionally have the same dimensions, for example according to the width and length directions.

Further preferably, the said base plate is divided into multiple base panels, and this at least according to directions perpendicular to the said length directions of said pieces.

In specific embodiments, to form said plate-shaped board, two or more of said pieces are attached to each other by joints, such as fingerjoints or dovetail joints or box joints or tongue and groove joints or butt joints or lap joints or miter joints, and further preferably by glue. Fingerjoints could also be indicated as combjoints. Said joints can be formed by milling.

Also in a specific embodiment, said plate-shaped board comprises two opposite surfaces and at least a levelling material is applied upon a said surface to form said base substrate, such that the base substrate preferably has a substantially flat surface, said levelling material preferably comprising one or more of the following substances: a thermoplastic material, wood fibers, wood dust, wood chips, glass fibers, a thermosetting resin, such as an acrylic resin or a melamine resin, or an inorganic material, such as chalk, MgO or cement. For example the levelling material could comprise lignocellulose material, such as wood chips, wood dust or wood fibers, and a thermoplastic and/or elastomeric binder such as polyvinyl butyral (PVB), polyvinyl butyrate, polyvinyl chloride (PVC), polyvinyl dichloride (PVdC), polypropylene (PP), polyethylene (PE), polyethylene terephthalate (PET), thermoplastic polyurethane (TPU), thermoplastic aliphatic polyester, such as polylactic acid (PLA), thermoplastic olefin (TPO) or such as synthetic rubber (neoprene), silicone, polyvinyl butyral and natural rubber (polyisoprene). Instead of a thermoplastic binder, a thermosetting resin, such as an acrylic resin or a melamine resin, could be used. If no decorative layer is applied upon said levelling layer or if said decorative layer is transparent, said levelling layer then forms the visible side of the newly made panel. The levelling material does not necessarily have to form a flat surface, since a flat surface is not always desired. The main function of the levelling material can be to connect the said pieces of a plate-shaped board comprising multiple pieces, to each other.

Additionally, or in an alternative embodiment where no levelling material has been applied, a base substrate with at least one flat surface can be obtained by performing a surface treatment such as sanding or peeling and/or by pressing. If a levelling material is present, the latter can be done before or after applying said levelling material.

In a preferred embodiment, the decorative base layer and optionally the balancing base layer is applied upon said base substrate to form said base plate, such that the formed panels are decorative panels comprising said layer-shaped substrate and at least a decorative layer made from said decorative base layer and optionally a balancing layer made from said balancing base layer, wherein said decorative base layer preferably comprises one or more of the following layers, as long as not contradictory:
a resin impregnated paper layer
a thermoplastic based layer, being a layer comprising thermoplastic material as a binder material wherein the thermoplastic material can or cannot make up at least half of the weight of said layer, with the thermoplastic material being for example PVC, PP, PE, PET. Said thermoplastic based layer can further comprise filling material, such as chalk or limestone, and/or plasticizers;
a lacquer layer, which has been for example UV and/or heat cured;
a veneer layer;
an oil layer;
a timber layer;
a print layer, for example a print layer obtained by direct printing or a printed (plastic) sheet or a printed paper. The printing can be done digitally or analogously;
a kraft paper layer;
a wear layer comprising for example wear resistant particles such as aluminum oxide particles or corundum;
a foamed layer;
a transparent layer;
a scrim or a net, such as a glass fiber scrim.

A said layer could be indicated by two or more of the abovementioned terms. For example a layer comprising thermoplastic material could also be a foamed layer and/or a printed layer. A resin impregnated paper layer can be a printed layer and can also be a kraft paper layer. The choice for the one or more of said following layers will also depend on the end-of-life panels or boards which are used to form the said pieces. For example laminate end-of-life panels comprising a lignocellulose substrate and resin impregnated papers, are suitable to make new laminate panels comprising a layer-shaped substrate made from said pieces, and one or more resin impregnated papers which form the decorative layer. For example SPC end-of-life panels are suitable to be make new SPC panels comprising a layer-shaped substrate made from said pieces, and one or more thermoplastic based layers which form the decorative layer. The decorative layer could consist of one transparent layer or only transparent layers if it is desirable that the layer-shaped substrate is visible.

Said decorative base layer can be directly or indirectly attached to the base substrate. For example one can use a separate glue, for example a separate glue layer to attach said decorative base layer to said base substrate. Said decorative base layer can for example be a HPL (High Pressure Laminate) comprising for example resin impregnated paper layers or it can be a veneer. Said decorative base layer can also be directly laminated to said base substrate. If said decorative base substrate comprises multiple layers, said layers can be laminated subsequently and separately, or all layers can be laminated simultaneously, for example in one pressing step, or some layers can be laminated simultaneously while others are laminated separately. The separate glue layer can be a resin impregnated sheet, such as a resin impregnated paper. The separate glue layer could also only comprise glue.

If the base substrate is made from one or more pieces of end-of-life laminate panels comprising a lignocellulose based substrate, said decorative base layer preferably comprises resin impregnated papers, with the resin preferably being a thermosetting resin such as a melamine resin or an acrylic resin, and/or veneer layers. Said resin impregnated papers for example comprise a print layer/décor layer, this being a paper that has been digitally or analogously printed, and a wear layer. Further preferably a balancing layer is present, this being a resin impregnated paper, with the resin preferably being a thermosetting resin such as a melamine resin or an acrylic resin. The balancing layer can also only comprise said resin, such that no paper is present.

If the base substrate is made of one or more pieces of end-of-life thermoplastic based panels, such as SPC panels or LVT panels, said decorative base layer can comprise one or more layers comprising thermoplastic material. Said layers further can comprise fillers, for example inorganic fillers such as chalk or limestone, and optionally plasticizers. Said layers can comprise a print layer and/or a wear layer. Said layers can comprise one or more UV lacquer layers. Said layers can comprise a veneer layer. Said layers can comprise a resin impregnated paper.

In a specific embodiment according to the invention, to form said plate-shaped boards, two or more of said pieces are placed, and preferably glued, together on top of each other, and are sliced according to a transverse direction, as such to form plate-shaped boards each comprising parts of each of the said pieces. Said plate-shaped boards can form said base plates as such or one or more transparent layers can be applied upon said plate-shaped boards, for example protective layers, to form said base plates, since said plate-shaped boards have a specific aesthetic appearance. Of course decorative base layers comprising a specific décor can also be applied. Said base plates can or cannot be further divided to form base panels and method steps can or cannot be performed to provide said base panels with coupling parts etc.

In a preferred embodiment the end-of-life panels or boards are rectangular shaped, square or oblong, and comprise at least two opposite edges with coupling parts, wherein said edges are removed, for example cut or sawn off, to form said plate-shaped or beam-shaped pieces. This cutting or sawing off can be performed with the aid of knives and/or lasers and/or saws. Preferably said end-of-life panels have two pair of opposites edges with coupling parts, and all said edges with coupling parts are cut off. Said coupling parts cannot negatively influence the strength of the substrate of the newly made panel. The latter is of uttermost importance if the newly made panel comprises milled coupling parts. Said cut off edges with coupling parts can be recycled in other processes or they can be burned to produce energy.

In an alternative embodiment the end-of-life panels or boards are rectangular shaped, square or oblong, and comprise at least two opposite edges with coupling parts, wherein at least some of these said edges with coupling parts are kept such that at least some of said pieces comprise coupling parts, wherein pieces comprising coupling parts are connected to each other at the height of the coupling parts to form said plate-shaped board. In this alternative embodiment waste is avoided and said end-of-life panels can be used completely. Of course in this alternative embodiment also shaping steps such as surface treatments steps that reduce the amount of material, such as sanding or peeling, can be used.

According to a variant of the invention, said one or more shaping steps can be omitted, such that each end-of-life panels or board forms, without any intermediate steps, a said plate-shaped or beam-shaped piece. Said one or more shaping steps can thus be optional, such that it is clear that all the embodiments described before this paragraph and after this paragraph, are not restricted to said shaping steps.

Said end-of-life panels or boards can comprise a substrate and at least an additional layer, wherein said pieces at least comprise material of said substrate and wherein preferably said substrate is a wood fiber board or a particle board. Further, to form said plate-shaped or beam-shaped pieces, said additional layer is then preferably at least partially removed, and this more preferably by one or more of the following actions: shaving, peeling, sanding, cutting, milling, sawing or delaminating. By removing at least said at least one additional layer, the layer-shaped substrate of said newly made panel can be more similar to the substrate of a traditionally made panel. For example if said newly made panels are laminate panels comprising lignocellulose material, one can use end-of-life laminates comprising a lignocellulose based substrate, such as particle board or fiberboard, and for example only use said lignocellulose based substrate to form said pieces. In this manner, the newly made panels can also comprise a layer-shaped substrate only comprising particle board or fiberboard. It can be desirable to remove at least partly one or more of said additional layers. For example said additional layers can comprise unwanted elements such as hard particles or a certain design or certain components that have a negative influence upon further method steps, such as laminating, direct printing, etc. Said removed material can be reused in other processes or can be burned for energy. This additional layer can be a decorative layer or can be part of a decorative layer. This additional layer can be a balancing layer. This additional layer can be multilayered. A said balancing layer will often not comprise hard particles and can be easily removed in full or partially. For example one could choose to at least partially remove said balancing layer and place said piece upside down to form newly made panels. This way the decorative layer does not need to be removed and more can be recycled of the end-of-life panels. If end-of-life panels are used comprising a substrate and a decorative layer on one side of said substrate and a balancing layer on the other side of said panel, wherein said decorative layer comprises hard particles, for example a wear layer comprising hard particles such as corundum, one could choose to peel off the decorative layer entirely or at least partially, as such to remove the corundum and to sand the balancing layer to form said pieces.

Alternatively, when said end-of-life panels or boards comprise a substrate and at least an additional layer, one can choose to keep said at least additional layer such that said pieces at least comprise material of said additional layer. Because of this, there can be less material waste and also, depending on said additional layer, positive influence upon the strength, lamination, etc. can be obtained.

In a specific embodiment the end-of-life panels or boards are pressed such that the plate-shaped or beam-shaped pieces have a thickness which lies in a thickness range that spans at most 1 mm, preferably at most 0.5 mm. For example said pieces could have a thickness of between 4.5 mm and 5.5 mm, preferably of between 4.75 mm and 5.25 mm. If other shaping steps are present, such as cutting, sawing, surface treatments, etc., this pressing is preferably the last shaping step and/or not the first shaping step. With the aid of pressing, a strong substrate can be obtained. Possible defects, such as loose parts or swelling due to moisture, which are a result of use of said end-of-life panels or boards can be eliminated or reduced by pressing. Further if one wants to connect two or more of said pieces to form a said plate-shaped board, it is preferred that said pieces have the same thickness. If a levelling material is used, less levelling material is needed if said pieces are pressed and/or if said pieces have the same thickness. Preferably said end-of-life panels or boards at least have a similar thickness and even more preferably all dimensions are similar. Also if pressing is not used, said end-of-life panels or boards preferably have a similar thickness and even more preferably all dimensions are similar. For example if said end-of-life panels are laminate panels with a wood based substrate of +/−8 mm thickness, and said pieces are made substantially of said substrate, said pieces can have a thickness of between 4 and 7 mm due to pressing. By pressing, for example a thickness reduction of between 0.1 and 4 mm can be obtained. Preferably a thickness reduction of at least 1 mm, more preferably at least 2 mm is obtained. One could press the end-of-life panels or boards each separately or with a limited number, and this whether or not after one or more shaping steps have been performed, such that significantly thickness reductions are possible.

Preferably the plate-shaped or beam-shaped pieces are arranged in the panels in their original orientation, being the orientation they had in the end-of-life panels or boards or wherein the plate-shaped or beam-shaped pieces are arranged in the panels upside down. This ensures that the material of said plate-shaped or beam-shaped pieces can be used in the most optimal way. Newly made panels, made from laminate end-of-life panels comprising a substrate, such as a particle board or a woodfiber board, and a top layer an optionally a balancing layer, wherein said substrate makes up more than half of the thickness of the end-of-life panel, can have a substrate that is quite similar to the substrate of said end-of life panel. The top layer of an end-of-life panel can comprises hard particles, such as corundum or aluminum oxide, can be embossed, can comprise a décor. By arranging said plate-shaped or beam-shaped pieces upside down in the newly made panels, it is ensured that said top layers, when they are not removed when making said plate-shaped or beam-shaped pieces, cannot negatively influence lamination of new layers upon said plate-shaped or beam-shaped pieces when forming new decorative panels. Further said balancing layers are normally more uniformly, do not comprise different colors and do not comprise irregular embossments, such that said balancing layers can be easily removed or treated when forming said plate-shaped or beam-shaped pieces, and lamination/printing upon said plate-shaped or beam-shaped pieces at the height of treated balancing layers or removed balancing layers can be done uniformly and in an easy manner.

In a very preferred embodiment, the end-of-life panels are floor panels, and said panels are floor panels, wherein the layer-shaped substrate of a said panel comprises at least one layer which consists of one plate-shaped piece obtained from one end-of-life panel, or a part of said one plate-shaped piece. With one end-of-life floor panel, one new panel is made.

According to a second aspect, this invention relates to a method for the production of panels, for example floor panels or wall panels or furniture panels, wherein said panels at least comprise a layer-shaped substrate, and a top layer, such as a decorative layer or a balancing layer, and an intermediate layer between said layer-shaped substrate and said top layer, wherein the method comprises the steps of:
providing end-of-life panels or boards;
comminuting said end-of-life panels or boards, into particles;
wherein said particles are supplied to form said intermediate layer and form at least 50 weight percentage of the intermediate layer, preferably at least 70 weight percentage.

If said panel comprises a top layer on both sides of the layer-shaped substrate, both top layers can be attached to the layer-shaped substrate with the aid of such an intermediate layer.

Preferably said particles form at least 90 weight percentage of the intermediate layer, more preferably said intermediate layer is completely made out of said particles. Additionally, glue and/or additives can be provided to form said intermediate layer.

With the aid of this method, end-of-life panels or boards can be reused and this without the need of complex recycling methods and/or melting steps. To comminute said end-of-life panels or boards into particles, shredding and/or grinding can be performed. Since these end-of-life panels or boards are used as intermediate layer, these are not located at the height of the visible surfaces, and cannot negatively influence the appearance of these panels. For example said particles can be used as glue to connect said layer-shaped substrate to said top layer, such that said intermediate layer than forms a glue layer. The average particle size of said particles, expressed as the D50 value or the median of the distribution, preferably is smaller than 10 mm, more preferably the D50 value is between 1 μm and 1 mm, preferably between 10 μm and 0.5 mm. In general it is remarked that, wherever median particle diameter D50 values are described herein, the median particle diameter D50 may be determined using laser granulometry, which may be performed in accordance with ISO 13320:2020. This is a dynamic light scattering technique using a laser with an emission wavelength of 632.8 nm, measuring at a scattering angle of 90 degrees. This technique may be performed, for example, with a Malvern® Mastersizer 2000 or with a Malvern® Mastersizer 3000. To perform the measurement of the particle size distribution, the respective particles need to be brought in a loose state, and can be dispersed in a liquid, such as water.

Said intermediate layer can substantially cover the complete layer-shaped substrate and as such form a barrier between the layered-shaped substrate and the top layer. However said intermediate layer can also only partially cover the layer-shaped substrate. For example said intermediate layer can be used to level the layer-shaped substrate and/or the bottom of the top layer.

Preferably said end-of-life panels or boards comprise thermoplastic material and to form said panels, at least a substrate layer is formed, said particles are strewn upon said substrate layer and are subjected to heat, wherein said substrate layer forms the layer-shaped substrate of a said panel and said strewn particles at least partly, and preferably entirely, form the said intermediate layer of the panel. Said end-of-life panels or boards are for example thermoplastic based panels, such as SPC, LVT, vinyl flooring, which can comprise a synthetic material composite comprising thermoplastic material and optionally fillers, such as organic or inorganic fillers, and/or optionally plasticizers. The organic fillers can comprise wood particles, such as wood fibers or wood dust. The inorganic fillers can for example comprise chalk or limestone. The weight ratio between the thermoplastic material and the fillers can be between 90:10 and 10:90, preferably between 80:20 and 20:80. For example the panel can comprise a filled synthetic material composite with an excess of thermoplastic material meaning that the weight ratio between the thermoplastic material and the fillers is higher than 50:50;
an excess of fillers meaning that the weight ratio between the thermoplastic material and the fillers is lower than 50:50;
the same amount of thermoplastic material and fillers, meaning that the weight ratio between the thermoplastic material and the fillers is 50:50.

The thermoplastic material can be polyvinylchloride, polyethylene, polypropylene, polyethylene terephthalate, etc.

Said filled synthetic material composite can or cannot be foamed. For example the end-of-life panels can be multilayered panels, wherein at least one layer is a foamed layer or a non-foamed layer, said layer comprising said filled synthetic material composite.

For example the end-of-life panels or boards can be SPC panels or LVT panels or WPC panels or wood plastic composite panels or sheet vinyl flooring. Said end-of-panels comprise thermoplastic material as binding agent, such that heated particles of said end-of-life panels will again have glue properties and thus are well suitable as intermediate layer in the production of newly made panels. The heating can occur with heating devices, such as infrared devices, and/or with the aid or pressure. Said pressure can be applied during lamination of said different layers with the aid of for example pressure rolls and/or with the aid of a continuous or discontinuous press. For example said particles can be strewn upon the substrate layer, optionally heated with the aid of for example infrared lights, wherein the decorative layer is then laminated/pressed/consolidated upon said strewn particles. During the abovementioned method steps, said particles will melt and adhere the decorative layer to the substrate layer. Said decorative layer can have one or more layers. When said decorative layer comprises two or more layers, the said decorative layer as such can be pressed/laminated upon said substrate layer with the (heated) particles in between or said layers can be subsequently attached to form said panel. In addition to said synthetic material, said end-of-life panels or boards can comprise additional components, such as fillers, plasticizers, reinforcement elements-such as glass fiber-, polyurethane layers, lacquers, veneer, etc. wherein said additional components can have positive or negative influences upon the quality of the particles. For example, said reinforcement elements can provide the panel with additional strength, said plasticizers can provide the intermediate layer with a certain softness, which can be beneficial for sound and ergonomics. If certain additional components are not wanted, one could perform, before the communicating of said end-of-life panels, method steps to remove said components at least partially, said method steps for example being the shaping steps as mentioned in the first aspect of this invention. For example if the end-of-life panels are multilayered and a top layer or a backing layer comprises unwanted components, one could remove said layers with the aid of for example one or more shaping steps as mentioned in this first aspect of the invention. This way only the parts of the end-of-life panels with the desired components get comminuted and form said particles. It is possible to shredder end-of-life SPC panels, LVT panels or sheet vinyl flooring entirely into said particles, such that no waste is present.

The substrate layer can be MDF, particle board, HDF, a thermoplastic based layer, a board comprising PIR/PUR, or a mineral based substrate. If the substrate layer is a thermoplastic based layer, it can or cannot be a foamed layer. It can comprise or consist of a filled synthetic material composite as described above. The substrate layer can have one or more reinforcement layers such as a glass fiber scrim.

In a very preferred embodiment the method is also according to an embodiment described in the first aspect. The terms used for this second aspect to name the different parts of the panel, are then the same terms as used in the first aspect. This method is for example used to form panels comprising an intermediate layer present between the decorative layer and the layer-shaped substrate, wherein the intermediate layer adheres the decorative layer to the substrate. This method relates for example to a method where
the decorative base layer is applied to the base substrate with a glue layer, the glue layer being formed by said particles, and the glue layer being the intermediate layer; and/or
a base substrate being formed by applying levelling material to the plate-shaped board, said levelling material comprising the said (melted) particles, and the leveling material being the intermediate layer; and/or
the balancing base layer is applied to the base substrate with a glue layer, the glue layer being formed by said particles, and the glue layer being the intermediate layer.

Alternatively said particles can be used as glue to connect said pieces to each other to form a plate-shaped board.

According to a third aspect, this invention relates to a panel, for example a floor panel or a wall panel, wherein said panel comprises at least a layer-shaped substrate, wherein said layer-shaped substrate comprises recycled material from end-of-life panels or boards, wherein said recycled material comprises plate-shaped or beam-shaped pieces, wherein said pieces are obtained by subjecting said end-of-life panels or boards to one or more of the following shaping steps: cutting, sawing, milling, pressing, performing surface treatments such as shaving, peeling or sanding, or delaminating—in case the end-of-life panels or boards are multi-layered—. Said shaping step could comprise delamination if said end-of-life panels are multilayered. A said panel comprises recycled material that has not been obtained from complex recycling processes. Said panel can thus be easily made out of end-of-life panels or boards.

Preferably the layer-shaped substrate comprises one said piece or comprises two are more of said pieces which lie next to each other according to the plane of the panel, wherein
said piece or said two or more pieces form at least half of the thickness of the substrate, preferably at least 70% of the thickness of the layer-shaped substrate, more preferably at least 90% and/or
said piece or said two or more pieces form at least half the weight of the substrate, preferably at least 70% of the weight the layer-based substrate, more preferably at least 90%.

Said layer-shaped substrate comprises the entire piece or pieces, or parts of said piece or pieces. During the production of said panel, method steps, such as milling coupling parts or dividing into panels from a bigger base plate, can result in the layer-shaped substrate not comprising said entire piece or pieces. Here the substrate of said panels is for more than the half of said thickness made out of end-of-life panels or boards. This means a large reduction in the amount of other raw material, for example non recycled raw material, needed to form said panel. Preferably the entire layer-shaped substrates of said panels, are mainly made from said end-of-life panels or boards. The orientation of said piece or pieces in the panels can be the same as in the end-of-life panels, or cannot be the same. For example the orientation of said piece or pieces in the panels can be upside down in comparison to the orientation in the end-of-life panels

In a preferred embodiment, said layer-shaped substrate comprises lignocellulose based material, such as particle board, MDF or HDF, and wherein said lignocellulose based material forms at least 80 percent of the thickness of said layer-shaped substrate, and wherein preferably said layer-shaped substrate comprises a resin impregnated paper. This preferred embodiment is beneficial if said end-of-life panels are laminate floor panels comprising an MDF/HDF substrate and resin impregnated papers that form a decorative layer and/or balancing layer, or decorative panels comprising a particle board or MDF/HDF substrate and one or more decorative layers and a balancing layer, said decorative layers and/or balancing layer for example comprising resin impregnated papers. Here, one can remove said resin impregnated papers or one cannot remove said resin impregnated papers, such that said end-of-life panels can be entirely or at least for the most part can be used to form new panels. Further a layer-shaped substrate not only comprising said lignocellulose material such as MDF, HDF or particle board can also have advantages. For example said layer-shaped substrate can have the desired strength, can be printable, can be easily laminated, can eliminate the need for a balancing layer, etc.

In a specific embodiment said panel comprises a decorative layer applied upon said layer-shaped substrate, wherein said layer-shaped substrate comprises a décor, for example a printed décor. This décor can or cannot be a printed décor, and can be for example a veneer layer, a resin impregnated printed paper, a printed thermoplastic based sheet, a timber layer, a directly printed layer, etc. For this embodiment it can easily be established that recycled end-of-life panels have been used, since a décor is present in a part that is not visible, namely the layer-shaped substrate.

In a very preferred embodiment the said panels are made according to the method described in the first aspect of the invention or according to the method described in the second aspect of the invention and referring to the first aspect of the invention. Here all the features and preferred embodiments of the first aspect of the invention and the second aspect referring to the first aspect, also apply to these panels.

According to a fourth aspect, this invention relates to a panel, for example a floor panel or a wall panel or a furniture panel, comprising two or more distinguishable base units, and an adhesive unit that provides adhesion between at least two of said base units, wherein said panel comprises recycled material from end-of-life panels or boards, wherein said end-of-life panels or boards comprise thermoplastic material, wherein at least said adhesive unit comprises said recycled material, wherein said material constitutes at least 50% by weight of said adhesive unit, preferably at least 80% by weight, most preferably at least 90% by weight. End-of-life panels or boards comprising thermoplastic material, such as thermoplastic based material composites, for example SPC panels, LVT panels, sheet vinyl flooring, are used for forming said adhesive unit.

In a preferred embodiment said panel is made according to the second aspect of the invention, wherein said at least two base units are the layer-shaped substrate and the top layer, and said adhesive unit is the intermediate layer.

In another embodiment said panel comprises a least one layer with multiple base units interconnected to each other by said adhesive unit, wherein preferably said multiple base units are preferably chosen from the list of: cellulosic particles, refined recycled PUR/PIR waste, refined lignocellulose boards. Said cellulosic particles can be wood particles such as wood chips, wood fibers, wood shavings or wood dust. Said panel can thus for example be a particle board, a wood fiber board, OSB (oriented strand board), a panel comprising refined recycled PUR/PIR waste, a flax board, a hemp board, etc.

In a preferred embodiment the end-of-life panels or boards, are multilayered, and comprises at least one substrate layer comprising thermoplastic material and optionally fillers, and one or more of the following layers
a lacquer layer, for example a polyurethane based lacquer layer;
a reinforcement layer, for example a glass fiber;
a veneer layer;
a soft layer;
an oil layer.
   Said layer, comprising thermoplastic material and optionally fillers, then preferably comprises said filled synthetic material composite as described above and preferably forms at least half the thickness of the substrate. Said filled synthetic material can or cannot be foamed. The weight ratio between the thermoplastic material and the fillers of said filled synthetic material can be between 90:10 and 10:90, preferably between 80:20 and 20:80. For example the filled synthetic material composite can have an excess of thermoplastic material, an excess of fillers, are the same amount of thermoplastic material and fillers, as described earlier in this description. For example said layer can have an excess of fillers and can be rigid. With a soft layer a layer is indicated that is softer than the substrate layer, for example if the substrate comprises a filled synthetic material composite with an excess of fillers, the soft layer can be a filled synthetic material composite with an excess of thermoplastic material and/or with plasticizers. Said soft layer can also be a rubber layer, a foamed thermoplastic based layer, etc. This soft layer could also be seen as part of the substrate layer when said substrate layer is multilayered. This soft layer can then be formed with the pieces of the first aspect of the invention, said pieces for example obtained from end-of-life soft flooring as described in the first aspect of the invention.

With the intention of better showing the characteristics of the invention, herein below, as an example without any limitative character, some embodiments are described, with reference to the following figures:

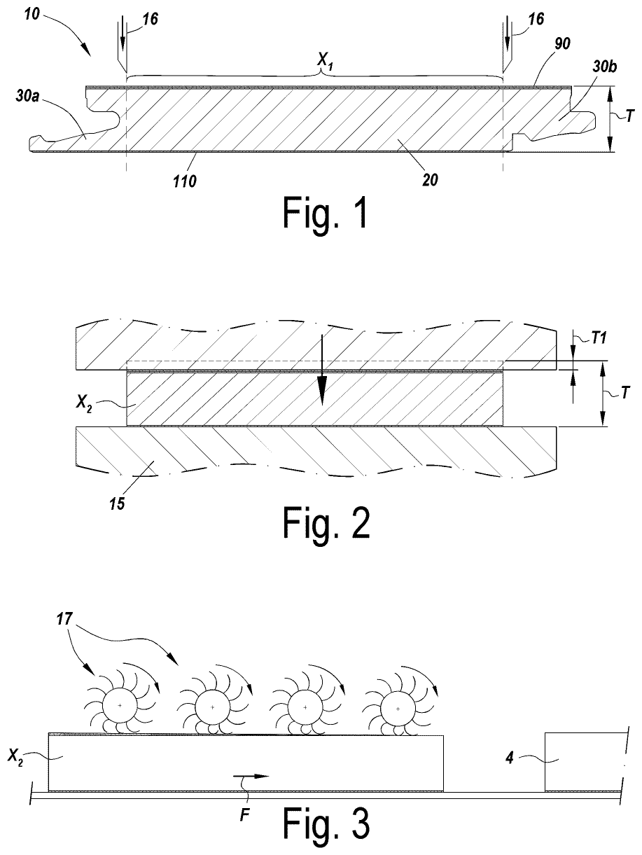

FIG. 1 shows a cross section of an end-of-life floor panel with coupling parts, a decorative layer and balancing layer, and schematically indicates the cutting of said coupling parts;

FIG. 2 shows said end-of-life floor panel of FIG. 1 of which the coupling parts have been cut off, wherein said end-of-life floor panel is further pressed;

FIG. 3 shows the end-of-life panel of FIG. 2 after the pressing, wherein said decorative layer is sanded off;

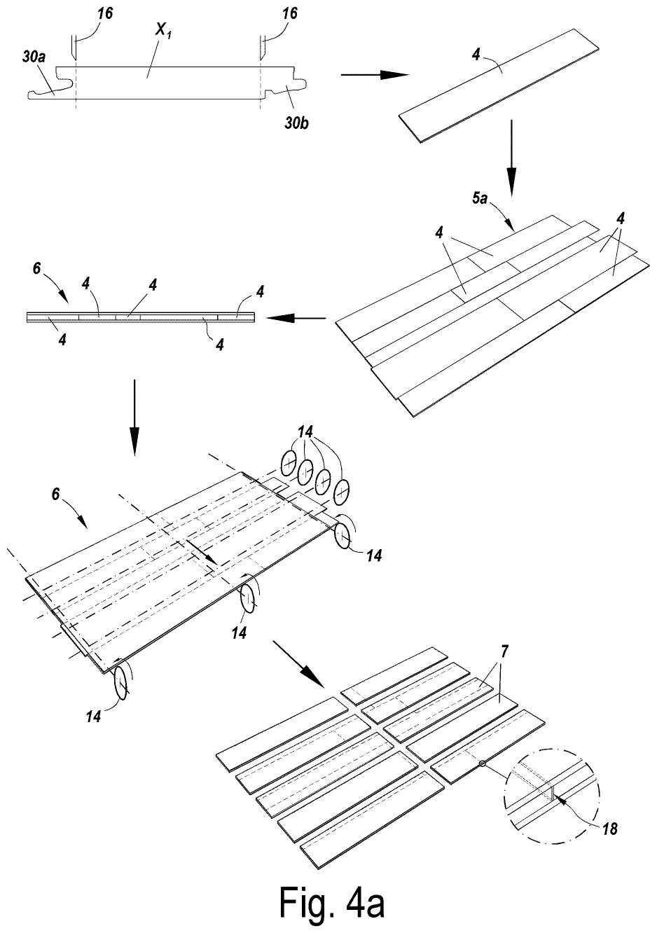

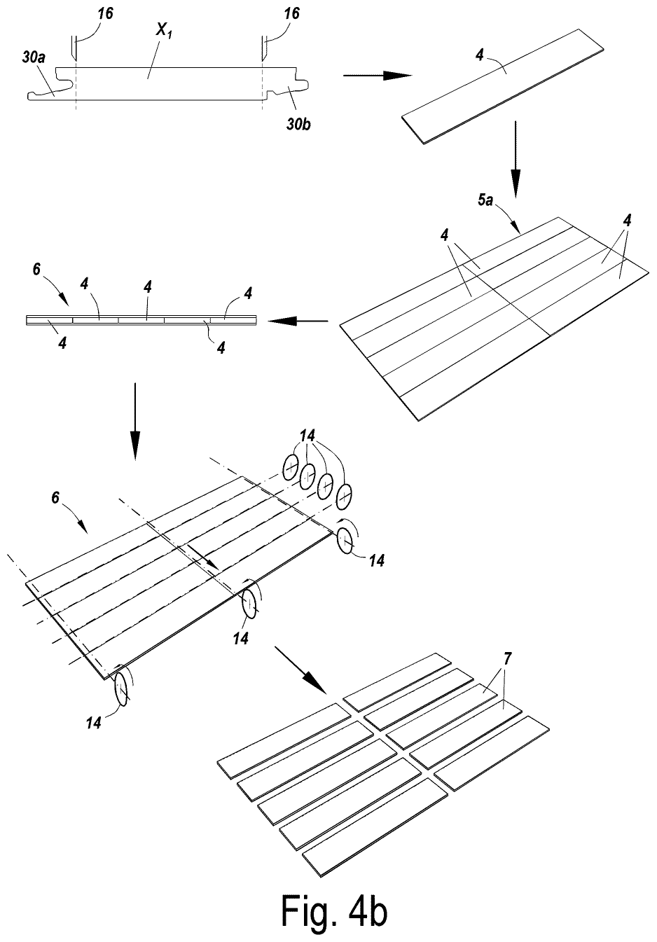

FIG. 4a shows some method steps of a first embodiment according to the first aspect of the invention to obtain new panels from end-of-life panels;

FIG. 4b shows some method steps of a second embodiment according to the first aspect of the invention to obtain new panels from end-of-life panels;

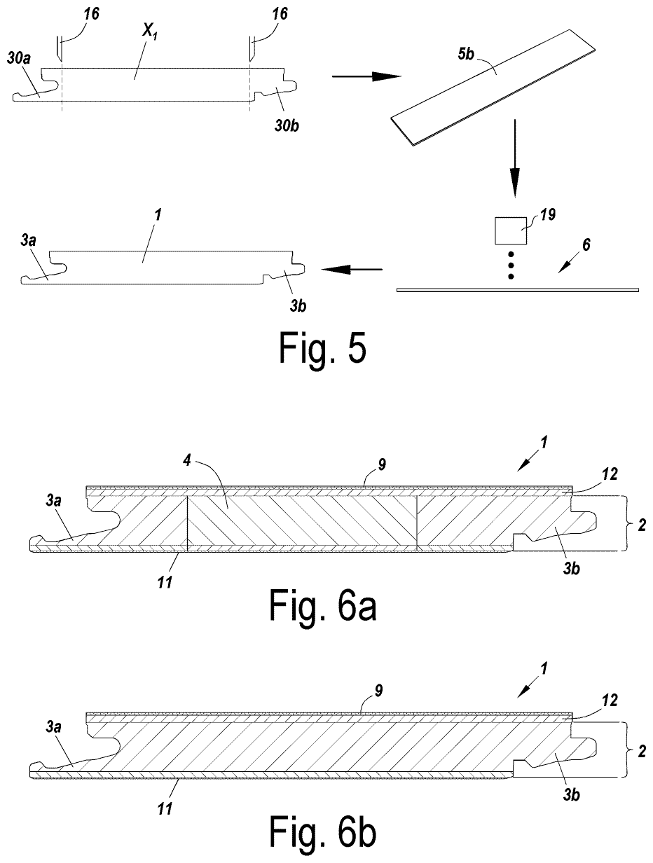

FIG. 5 shows some method steps of a third embodiment according to the first aspect of the invention to obtain new panels from end-of-life panels;

FIG. 6a shows a cross section of a new panel made according to the first embodiment;

FIG. 6b shows a cross section of a new panel made according to the second embodiment;

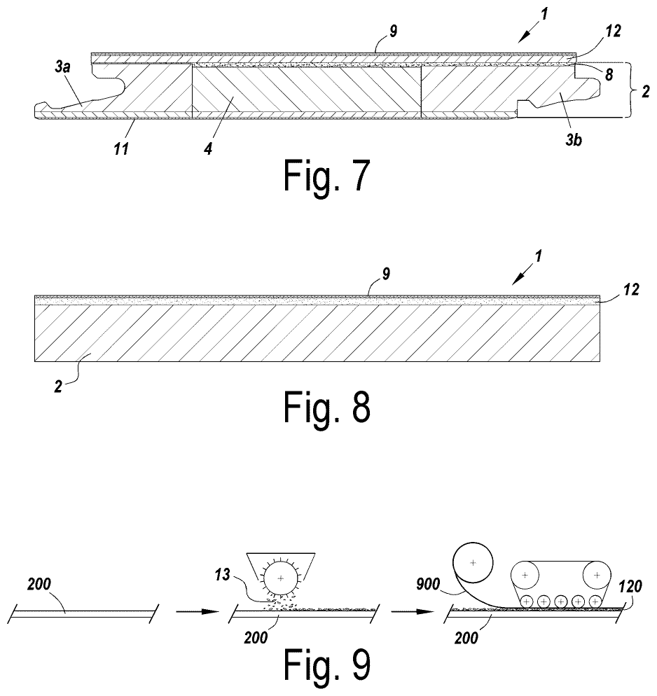

FIG. 7 shows a cross section of a new panel made according to a variant of the first embodiment;

FIG. 8 shows a cross section of a new panel made according to the second aspect of the invention;

FIG. 9 shows some method steps according the second aspect of the invention;

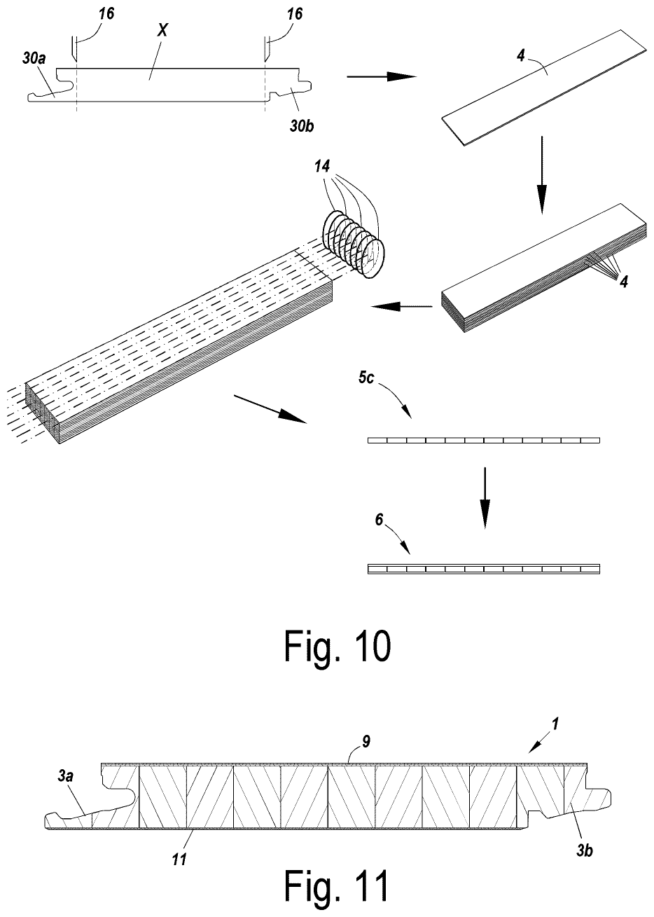

FIG. 10 shows some method steps of a fourth embodiment according to the first aspect of the invention to obtain new panels from end-of-life panels;

FIG. 11 shows a cross section of a new panel made according to the fourth embodiment;

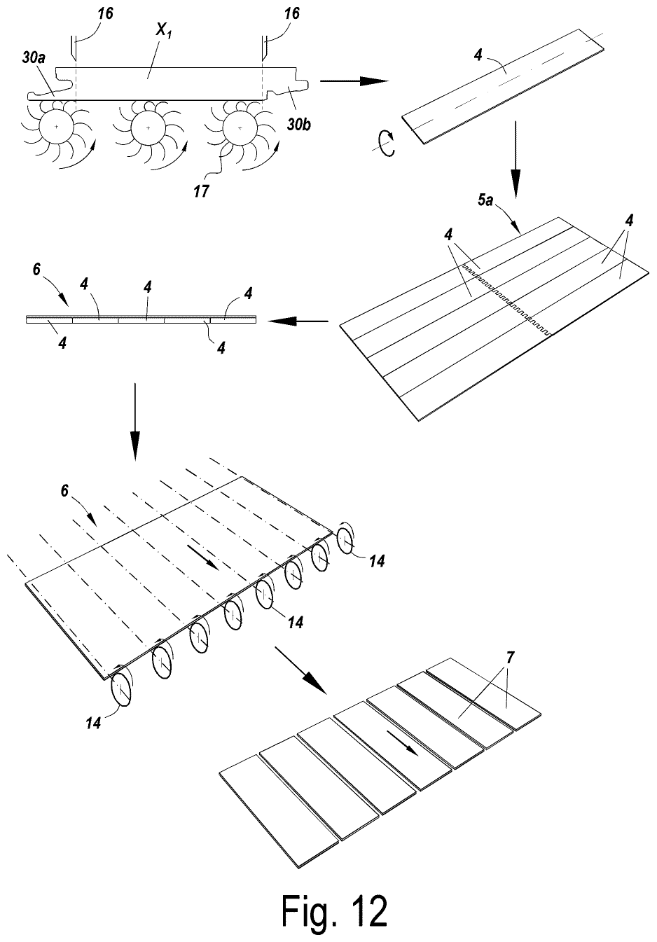

FIG. 12 shows some method steps of a fifth embodiment according to the first aspect of the invention to obtain new panels from end-of-life panels;

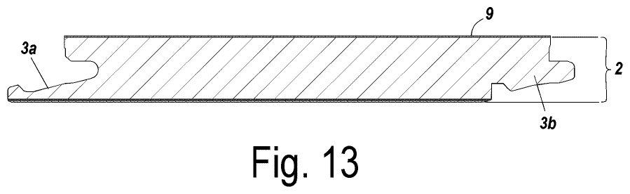

FIG. 13 shows a cross section of a new panel made according to the fifth embodiment.

The figures describe some embodiments according to the invention to recycle end-of-life floor panels (10) and make new floor panels (1) from them. The figures relate to floor panels, however the features shown, are also applicable for making all type of panels, such as floor panels, wall panels and furniture panels out of all types of end-of-life panels and boards.

FIGS. 1 to 7, 10 and 11 to 13 relate to the first and the third aspect of the invention and relate to a method for the production of panels (1), wherein said panels (1) comprise a layer-shaped substrate (2) comprising recycled material from end-of-life panels (10), wherein the method comprises the step of providing end-of-life panels (10) and further comprises the step of shaping said end-of-life panels (10) into plate-shaped pieces (4) by subjecting the end-of-life panels (10) to one or more of the following shaping steps: cutting, sawing, milling, pressing, performing surface treatments such as shaving, peeling or sanding, wherein said pieces (4) form said recycled material and wherein preferably said recycled material forms at least half the thickness of said layer-shaped substrate (2).

FIG. 1 shows an end-of-life floor panel (10). This floor panel (10) is a rectangular panel comprising a substrate (20), a decorative layer (90) on top of the substrate (20) and a balancing layer (110) at the bottom of the substrate (20). The decorative layer (90) shown in FIG. 1 has two sublayers. Such a build up is typical for laminate floor panels (10) which have an MDF/HDF substrate (20), a resin impregnated paper layer which forms the balancing layer (110) and at least two resin impregnated paper layers that form the decorative layer (90). This decorative layer (90) comprises for example, seen from the bottom to the top, a resin impregnated printed paper layer having a décor and a resin impregnated paper layer comprising wear resistant particles, such as aluminum oxide or corundum, to provide the decorative layer (90) with the desired wear resistance. Of course this does not exclude that the end-of-life panel can be thermoplastic based floor panel, such as SPC, LVT, WPC or wood plastic composite, and/or this does not exclude laminates having another decorative layer (90) and/or balancing layer (110), and/or panels having veneer layers and/or timber layers. Thermoplastic based end-of-life floor panels (10) have a thermoplastic based substrate comprising thermoplastic material and optionally fillers and/or optionally plasticizers and a decorative layer comprising one or more of the following sublayers: a direct print layer, a printed plastic sheet, a thermoplastic based wear layer, a lacquer layer, a veneer layer, a resin impregnated paper, etc.

As can be seen in FIG. 1 this end-of-life panel (10) has at least a first pair of opposite edges with coupling parts (30a, 30b). Preferably this end-of-life panel (10) will also have a second pair of opposite edges with coupling parts. In FIG. 1 the shown coupling parts (30a, 30b) are in the form of a tongue (30b) at one edge of the first pair of opposite edges and a groove (30a) at the other edge of the first pair of opposite edges, however all types of coupling parts can be present. This coupling parts (30a, 30b) of the first pair of opposite edges are removed by cutting knives (16), however these coupling parts (30a, 30b) could also be removed by other devices, for example the coupling parts (30a, 30b) can be removed with the aid of a laser device, a sawing device, milling tools, etc. If also the second pair of opposite edges comprises coupling parts, these coupling parts are preferably removed. The removal of said coupling parts (30a, 30b) forms a first said shaping step and the result of removing said coupling parts (30a, 30b) is a first semi-finished piece (X₁) of the end-of-life panel (10) which will then later on form the said plate-shaped piece (4).

As shown in FIG. 2, this first semi-finished piece (X₁) is subjected to a second shaping step, namely a pressing step. Here the first semi-finished piece (X₁) is pressed by a press (15), this can be in a continuous process or a discontinuous process. As can be seen in FIG. 2, by performing said pressing step, the thickness (T) of the first semi-finished piece (X₁) is reduced, such that a second semi-finished piece (X₂) is formed with a thickness (T−T1). This reduction in thickness is mainly obtained by the reduction of the thickness of the substrate (20). Preferably the pressing step ensures that the obtained second semi-finished pieces (X₂) of several end-of-life panels (10) all have a thickness (T) in the same range, wherein this range spans at most 1 mm, preferably at most 0.5 mm. This is important for the further method steps to form new panels (1) as explained further on.

This second semi-finished piece (X₂) is subjected to a third shaping step, namely sanding, as can be seen in FIG. 3. The second semi-finished piece (X₂) is transported past a sanding device (17) according to a direction (F), and this to remove said decorative layer (90) gradually. With the third shaping step the decorative layer (90) is completely removed. However, it is also possible to remove the decorative layer (90) only in part and/or to remove the balancing layer (110) completely or in part. The result is a said plate-shaped piece (4) that forms said recycled material. Since the balancing layer (110) normally does not comprise wear resistant particles, one could choose to at least partially remove said balancing layer (110) instead of said decorative layer (90), since this could be done very easily. Said pieces (4) are then preferably oriented upside down in the newly made panels (1).

The order presented here of the abovementioned shaping steps is only one possible order. For example the sanding can be done after the pressing, and/or the couplings parts (30a, 30b) can be removed after the pressing and/or sanding. Also not all these shaping steps are necessary. For example, one could not perform the pressing step and/or the sanding step and/or one could not remove the coupling parts (30a, 30b).

As can be seen in FIGS. 1 to 3, the balancing layer (110) is not removed during the shaping steps. However, as already indicated above, in addition to the at least partial removal of the decorative layer (90), the balancing layer (110) can be completely or partially removed. Of course, the opposite can also be the case, where the decorative layer (90) is not removed during the shaping steps, and only the balancing layer (110) is at least partially removed during the shaping steps.

Depending on the end-of-life panels (10) and the dimensions of said obtained pieces (4), one could choose between different embodiments to obtain new panels (1). In these figures five possible embodiments are shown.

In the embodiment shown in FIG. 4a, the dimensions of said plate-shaped pieces (4), namely the length and/or the width differ. The reason for this can be that the end-of-life floor panels (10) are different sized floor panels (10) that come from different batches. The end-of-life floor panels (10) and/or the pieces (4) do not have to sorted to size. As can be seen in FIG. 4a, at least the coupling parts (30a, 30b) of the end-of-life floor panels (10) are removed and preferably also the other shaping steps shown in FIGS. 2 and/or 3 are performed. Several of said pieces (4) are glued together in such a way that said pieces (4) extend next to each other in the same plane and form a plate-shaped board (5a). As shown in FIG. 4a, an additional glue (18) is used to glue said pieces (4) to each other, for example a thermosetting resin such as melamine resin. However, depending on the composition of the pieces (4), it can be that such an additional glue (18) is not necessary. For example if said pieces (4) comprise thermoplastic material, said pieces (4) can be connected to each other at their edges by heat and/or pressure which causes the thermoplastic material to melt at least at the height of said edges of the pieces (4) to connect said pieces (4) to each other at the height of the edges. Alternatively, said pieces (4) are only placed next to each to form said plate-shaped board (5a). The plate-shaped board (5a), as shown in FIG. 4a, is further processed. For example, levelling material (8) can be added to at least one surface of the plate-shaped board (5a) to form a base substrate. Said plate-shaped board (5a) could also form the base substrate. A decorative base layer and optionally a balancing base layer is then applied to the base substrate as such to form a base plate (6). This base plate (6) is divided into smaller base panels (7) with the aid sawing devices (14). As can be seen in FIG. 4a, the division into base panels (7) takes place independently from the position of said pieces (4) in the base plate (6), such that each base panel (7) can comprise (parts of) different pieces (4) and also said base panels (7) can comprise said additional glue (18). Said base panels (7) can form the newly made panels (1) or said base panel (7) can be further processed to form the newly made panels (1), for example they can be milled to provide them with coupling parts (3a, 3b).

In the embodiment shown in FIG. 4b, the dimensions of said plate-shaped pieces (4), namely the length and/or the width are all the same. The reason for this can be that the end-of-life floor panels (10) are the same sized floor panels (10). This can be obtained by using end-of-floor panels (10) from the same or similar batches, but preferably this is obtained by sorting the end-of-life panels (10) and/or the said pieces (4) to size and/or by making similar shaped pieces (4). As can be seen in FIG. 4b, at least the coupling parts (30a, 30b) of the end-of-life floor panels (10) are removed and preferably also the other shaping steps shown in FIGS. 2 and 3 are performed. Several of said pieces (4) are glued (or are only placed) together in such a way that said pieces (4) extend next to each other in the same plane and form a plate-shaped board (5a). As shown in FIG. 4b, an additional glue (18) is used to glue said pieces (4) to each other, for example a thermosetting resin such as melamine resin. However, depending on the composition of the pieces (4), it can be that such an additional glue (18) is not necessary. For example if said pieces (4) comprise thermoplastic material, said pieces (4) can be connected to each other at their edges by heat and/or pressure which causes the thermoplastic material to melt at least at the height of said edges of the pieces (4) to connect said pieces (4) to each other at the height of the edges. Said plate-shaped board (5a) is than further processed. For example, levelling material (8) can be added to at least one surface of the plate-shaped board (5a) to form a base substrate. Said plate-shaped board (5a) could also form the base substrate. A decorative base layer and optionally a balancing base layer is then applied to the base substrate as such to form a base plate (6). This base plate (6) is divided into smaller base panels (7) with the aid sawing devices (14) and this at the height of the intersection between adjacent pieces (4). The result is that each base panel (7) comprises only (part of) one said piece (4). With part of one said piece (4) is indicated that there can be some loss, for example obtained by sawing. Further these base panels (7) preferably do not comprise said additional glue (18). This has the advantage that said additional glue (18) cannot negatively influence the strength of the newly made panel (1) and cannot negatively influence optional further method steps of the base panels (7) such as milling.

In the embodiment shown in FIG. 12, the dimensions of said plate-shaped pieces (4), namely the length and/or the width are all the same. The reason for this can be that the end-of-life floor panels (10) are the same sized floor panels (10). This can be obtained by using end-of-floor panels (10) from the same or similar batches, but preferably this is obtained by sorting the end-of-life panels (10) and/or the said pieces (4) to size. As can be seen in FIG. 12, at least the coupling parts (30a, 30b) of the end-of-life floor panels (10) are removed and the lowermost layer is sanded. Preferably also the other shaping steps shown in FIGS. 2 and/or 3 are performed. Preferably the end-of-life panels (10) are laminate floor panels comprising a woodfiber board substrate (20), for example a HDF board, a top layer (90) laminated upon the upper surface of the substrate (20) and a balancing layer (110) laminated upon the bottom surface of the substrate (20). The top layer (90) comprising two or more resin impregnated paper layers, for example a resin impregnated printed paper layer which forms the décor layer and a transparent/translucent wear layer, which is preferably a resin impregnated paper layer comprising hard particles such as corundum. The balancing layer (110) comprises a resin impregnated paper layer. Preferably said balancing layer (110) gets sanded. Several of said pieces (4) are attached to each other with the aid of glue and fingerjoints in such a way that said pieces (4) extend next to each other in the same plane and form a plate-shaped board (5a). The glue can be a thermosetting resin such as melamine resin. However, this additional glue (18) can be omitted. Said plate-shaped board (5a) is than further processed. For example, levelling material (8) can be added to at least one surface of the plate-shaped board (5a) to form a base substrate. Said plate-shaped board (5a) could also form the base substrate. A decorative base layer and optionally a balancing base layer is then applied to the base substrate as such to form a base plate (6). The orientation of the said pieces (4) is such that the decorative base layer is applied upon the said sanded lowermost layer, thus the said pieces (4), in the base plate (6) have an upside down orientation with regard to their original orientation in the end-of-life floor panel (10). This base plate (6) is divided into smaller base panels (7) with the aid sawing devices (14) and this according to sawing lines which are perpendicular to the length direction of said pieces (4). The result is that each base panel (7) comprises parts of pieces (4). Said base panels (7) are then further processed to form new panels (1), for example coupling parts (3a, 3b) are milled.

FIG. 13 shows a cross section of a said new panel (1) made according to the fifth embodiment and wherein the end-of-life panel (10) is a preferred laminate floor panel as described above. This panel (1) comprises a layer-shaped substrate (2) and a decorative layer (9). The substrate (2) comprising from top to bottom: woodfiber board and top layer of the end-of-life panel (10). The decorative layer (9) comprises two resin impregnated papers, for example, from bottom to top, a resin impregnated printed paper layer and a translucent/transparent resin impregnated paper layer on top which forms the wear layer and which also comprises corundum.

In the embodiment shown in FIG. 10, the dimensions of said plate-shaped pieces (4), namely the length and/or the width are preferably all the same. The reason for this can be that the end-of-life floor panels (10) are the same sized floor panels (10). This can be obtained by using end-of-floor panels (10) from the same or similar batches, but preferably this is obtained by sorting the end-of-life panels (10) and/or the said pieces (4) to size. As can be seen in FIG. 10, at least the coupling parts (30a, 30b) of the end-of-life floor panels (10) are removed and optionally the other shaping steps shown in FIGS. 2 and 3 are performed. Several of said pieces (4) are glued together in such a way that said pieces (4) extend above each other to form a stack of said pieces (4). Depending on the type of end-of-life panels (10) and the preformed shaping steps, an additional glue can be used to glue said pieces (4) on top of each other or no additional glue can be used. For example if said end-of-life panels (10) are laminate panels comprising a lignocellulose based substrate and resin impregnated paper layers which form the decorative layer (90) and the balancing layer (110), one can use a thermosetting resin, such as melamine resin to glue said pieces (4) together and this independently of the shaping steps, for example independently from the (partial) removal of the decorative layer (90) and/or balancing layer (110) to form the said pieces (4). If the said end-of-life panels (10) are thermoplastic based panels comprising a thermoplastic based substrate and optionally additional layers, one can use no resin or thermoplastic material to glue said pieces (4) together. As shown in FIG. 10, said stack of pieces (4) is then sawn with sawing devices (14) transversally and this to form plate-shaped boards (5c) which comprise parts of all said pieces (4) of one said stack of pieces (4). Further preferably a decorative base layer, which is preferably a transparent layer, is applied to a said plate-shaped board (5c) and optionally a balancing base layer is applied to said plate-shaped board (5c) to form a said base plate (6). The decorative base layer and the balancing layer can be identical layers. Here the step of making a bigger base plate (6) and then dividing this base plate (6) into smaller base panels is not present. The base plate (6) forms the base panel (7) and can have optionally MDF end-parts (not shown). These end-parts have than been preferably glued to the plate-shaped board (5c) before applying said decorative base layer and said balancing base layer. With the aid of said MDF end-parts one can easily mill coupling parts in this base panel (7) to form a newly made panel (1). However if said MDF end-parts are not present, this does not mean that coupling parts (3a, 3b) cannot be milled into said base panel (7). The latter is shown in FIG. 11. As can be seen in FIG. 11, the panel (1) comprises a balancing layer (11), a decorative layer (9) and a substrate made from parts of all said pieces (4) of one said stack of pieces (4). The coupling parts (3a, 3b) are each milled in two adjacent said parts of pieces (4).

Another embodiment of the first aspect of the invention is shown in FIG. 5. Here one single new floor panel (1) is made from one single end-of-life floor panel (10). Said end-of-life panel (10), as shown in FIG. 5, has coupling parts (30a, 30b). These coupling parts (30a, 30b) are removed and optionally other shaping steps are performed to form a said piece (4). If said end-of-life panel (10) has a decorative layer (90) and/or a balancing layer (110), said layers (90, 110) are preferably not removed. Said piece (4) forms the plate-shaped board (5b) and is then directly printed with the aid of a direct printer (19). The removal of said a decorative layer (90) and/or a balancing layer (110) will depend on the fact of one of said layers (90, 110) is directly printable or not. For example one can choose to directly print upon the balancing layer (110), since the balancing layer (110) of an end-of-life panel (10) might be less damaged than the decorative layer (90) and also will not have a décor that can negatively influence the direct print. A sanding step may be performed upon said balancing layer (110) before said direct printing. After the direct printing, the base plate (6) is formed and said base plate (6) forms the base panel (7). Preferably coupling parts (3a, 3b) are milled in said base plate (6) to form the said new panel (1).

FIG. 6a shows a cross section of a new floor panel (1) which can be made by the method shown in FIG. 4a. FIG. 6b shows a cross section of a new floor panel (1) which can be made by the method shown in FIG. 4b or shown in the FIG. 5, with the difference that instead of direct printing, a decorative base layer and a balancing base layer are applied during production.

The newly made floor panel (1) as shown in FIG. 6a, comprises a layer-shaped substrate (2), a decorative layer (9) and a balancing layer (11). Said layer-shaped substrate (2) comprises (parts of) different pieces (4) which are glued to each other, preferably with the aid of a said additional glue (18).

As can be seen in FIG. 6a, said layer-shaped substrate (2) only comprises said (parts of) pieces (4) and said additional glue (18). Said decorative layer (9) is attached to said layer-shaped substrate (2) by means of an intermediate glue layer (12). This intermediate glue layer can be a thermosetting glue, such as a melamine resin. However, said intermediate layer (12) can also be produced according to the second aspect of the invention (see further). This intermediate glue layer (12) is optional, since the decorative layer (9) could also be directly attached to the layer-shaped substrate (2). Said decorative layer (9) is for example a high pressure laminate (HPL). Other possibilities are for example decorative layers comprising a veneer layer, a timber layer, a plastic sheet layer, a resin impregnated paper, etc. Said panel (1) comprises coupling parts (3a, 3b). The layer-shaped substrate (2) allows milling of said coupling parts (3a, 3b).

As can be seen in FIG. 6b and which can be deduced from FIG. 4b, said layer-shaped substrate (2) is made of only one said piece (4). Said decorative layer (9) is attached to said layer-shaped substrate (2) by means of an intermediate glue layer (12). This intermediate glue layer can be a thermosetting glue, such as a melamine resin. However, said intermediate layer (12) can also be produced according to the second aspect of the invention (see further). This intermediate glue layer (12) is optional, since the decorative layer (9) could also be directly attached to the layer-shaped substrate (2). Said decorative layer (9) is for example a high pressure laminate (HPL). Other possibilities are for example decorative layers comprising a veneer layer, a timber layer, a plastic sheet layer, a resin impregnated paper, etc. Said panel (1) comprises coupling parts (3a, 3b). The layer-shaped substrate (2) allows milling of said coupling parts (3a, 3b)

FIG. 7 shows another embodiment of a new floor panel (1) which can be made by the method shown in FIG. 4a. In this embodiment levelling material (8) is used. The use of levelling material (8) is advantageous if, during production, at least one of the surfaces of the formed plate-shaped board (5a) is not flat. By using levelling material (8), for example a mixture of lignocellulose material-such as wood chips, wood dust or wood fibers- and a binder-such as polyvinyl butyral (PVB), polyvinyl butyrate, polyvinyl chloride (PVC), polyvinyl dichloride (PVdC), polypropylene (PP), polyethylene (PE), polyethylene terephthalate (PET), thermoplastic polyurethane (TPU), thermoplastic aliphatic polyester, such as polylactic acid (PLA), thermoplastic olefin (TPO) or such as synthetic rubber (neoprene), silicone, polyvinyl butyral and natural rubber (polyisoprene) or an acrylate-, a base substrate with flat surfaces can be obtained upon which layers such as decorative layers (9) and/or balancing layers (11) can be easily applied. If said levelling material (8) comprises lignocellulosic material, other layers, such as resin impregnated papers, can well attach to said base substrate. Said layer-shaped substrate (2) comprises (parts of) different pieces (4) which are glued to each other, preferably with the aid of a said additional glue (18), and also comprises said levelling material (8). Said decorative layer (9) is attached to said layer-shaped substrate (2) by means of an intermediate glue layer (12). This intermediate glue layer can be a thermosetting glue, such as a melamine resin. However, said intermediate layer (12) can also be produced according to the second aspect of the invention (see further). This intermediate layer (12) is optional, since the decorative layer (9) could also be directly attached to the layer-shaped substrate (2). Said decorative layer (9) is for example a high pressure laminate (HPL). Other possibilities are for example decorative layers comprising a veneer layer, a timber layer, a plastic sheet layer, resin impregnated paper etc. Said panel (1) comprises coupling parts (3a, 3b). The layer-shaped substrate (2) allows milling of said coupling parts (3a, 3b). The decorative layer (9) is also optional, the levelling material (8) could form the outside of the panel (1).

FIG. 8 shows a newly made panel (1) which can be made according to the second aspect of the invention. This panel (1) comprises a layer-shaped substrate (2), an intermediate layer (12) and a decorative layer (9). Here the intermediate layer (12) comprises recycled material. FIG. 9 shows some method steps of the second aspect of the invention. Firstly a substrate layer (200) is produced. This substrate layer (200) can or cannot be a base substrate, as disclosed in the first aspect of the invention. This substrate layer (200) can thus be made with fresh raw material, for example fresh wood fibers or wood chips or thermoplastic material. This substrate layer (200) can also be made with recycled raw material, for example with recycled wood fibers or wood chips or thermoplastic material. This substrate layer (200) can also be made up from said pieces (4). The intermediate layer (12) is obtained by shredding thermoplastic based end-of-life panels (10) or boards into particles (13). With thermoplastic based end-of-life panels (10) or boards is for example indicated SPC panels or LVT panels or vinyl sheet flooring, etc. These particles (13) are strewn upon the substrate layer (200) and heated, for example with infrared lamps, such that said particles (13) will melt and forms a, at least partly and preferably fully, melted layer (120) upon said substrate layer (200). At least one plastic sheet (90) is then laminated upon said substrate layer (200) with the melted layer (120) to form a base panel. Because said shredded particles (13) are only heated before lamination, this ensures that the quality of said thermoplastic material does not deteriorate too much. This base panel is then optionally divided into smaller panels, and coupling parts (3a, 3b) are formed, for example milled, to form a said panel (1) as shown in FIG. 8. Said melted layer (120) forms the intermediate layer (12). The plastic sheet (90) forms the decorative layer (9). It is clear that such a melted layer (120) can also be used to attach a decorative base layer to the base substrate in the first aspect of the invention.

In these figures the panels (1) only comprise a balancing layer (11) at their bottom. However it is possible that these panels (1) have a softer layer at the height of their bottom, for example attached to said balancing layer (11). This can be a so-called pad-attached. In a very preferred embodiment this pad-attached is made from end-of-life soft flooring, such as sheet vinyl flooring, or linoleum flooring, or carpets, or rugs, or LVT panels. Preferably said end-of-life soft flooring is then cut to the desired form and attached to said newly made panels (1), and this for example before or after the dividing of a said base plate into smaller base panels, or before or after the milling of said coupling parts (3a, 3b). It is therefore possible that newly made panels (1) comprises different layers that comprise recycled material, with for example a layer-shaped substrate (2) made from pieces (4), preferably rigid pieces (4) obtained from for example laminate and/or SPC end-of-life panels (10), a pad-attached made from end-of-life soft flooring and optionally a glue layer (12) made from shredded thermoplastic based end-of-life panels (10) or boards.

The present invention is in no way limited to the herein above-described embodiment; on the contrary, such method can be realized according to various variants, without leaving the scope of the present invention, as defined by the appended claims.

1.-27. (canceled)

28. A method for the production of panels, wherein said panels at least comprise a layer-shaped substrate comprising recycled material from end-of-life panels or boards,
wherein the method comprises the step of providing end-of-life panels or boards,
wherein the method further comprises the step of shaping said end-of-life panels or boards into plate-shaped or beam-shaped pieces by subjecting the end-of-life panels or boards to one or more of the following shaping steps: cutting, sawing, milling, pressing, performing surface treatments such as shaving, peeling or sanding, or delaminating;
wherein said plate-shaped or beam-shaped pieces form said recycled material and
wherein said recycled material forms at least half the thickness of said layer-shaped substrate.

29. The method according to claim 28, wherein to form said panels,
a said piece forms a plate-shaped board or two or more of said pieces form said plate-shaped board;
said plate-shaped board forms a base substrate or one or more layers are applied upon said plate-shaped board to form said base substrate;
said base substrate forms a base plate, or a decorative base layer and/or a balancing base layer is applied upon said base substrate to form said base plate;
said base plate is divided into multiple smaller base panels, or said base plate forms said base panel;
said base panel forms the panel, or said base panel is subjected to one or more method steps, for example milling to form coupling parts, to form a said panel, such that each panel comprises a layer-shaped substrate made from a said piece or made from two or more of said pieces.

30. The method according to claim 29, wherein, to form said plate-shaped board, two or more of said pieces are placed next to each other, and attached to each other and/or glued together, in such a way that said pieces extend next to each other according to the plane of the plate-shaped board.

31. The method according to claim 30, wherein said base plate is divided into multiple base panels.

32. The method according to claim 31, wherein said dividing into multiple base panels is at least at the height of sections where two said pieced adjoin.

33. The method according to claim 30, wherein said pieces are oblong shaped and the length directions of said pieces extend in the same direction in the plate-shaped board and
wherein the said base plate is divided into multiple base panels, and this at least according to directions perpendicular to the said length directions of said pieces.

34. The method according to claim 30, wherein to form said plate-shaped board, two or more of said pieces are attached to each other by joints, such as finger joints or dovetail joints or box joints.

35. The method according to claim 29, wherein said plate-shaped board comprises two opposite surfaces and at least a levelling material is applied upon a said surface to form said base substrate, such that the base substrate has a substantially flat surface.

36. The method according to claim 29, wherein the decorative base layer is applied upon said base substrate to form said base plate, such that the formed panels are decorative panels comprising said layer-shaped substrate and at least a decorative layer made from said decorative base layer,
wherein said decorative base layer comprises one or more of the following layers, as long as not contradictory:
a resin impregnated paper layer;
a layer comprising thermoplastic material;
a lacquer layer;
a veneer layer;
a timber layer;
a print layer;
an oil layer.

37. The method according to claim 29, wherein to form said plate-shaped boards, two or more of said pieces are placed and glued, together on top of each other to form a stack of said pieces, and said stack is sliced according to a transverse direction, as such to form plate-shaped boards each comprising parts of each of the said pieces.

38. The method according to claim 28, wherein the end-of-life panels or boards are rectangular shaped, square or oblong, and comprise at least two opposite edges with coupling parts,
wherein said edges are removed, for example cut or sawn off, to form said plate-shaped or beam-shaped pieces.

39. The method according to claim 28, wherein said end-of-life panels or boards comprise a substrate and at least an additional layer,
wherein said pieces at least comprise material of said substrate and
wherein preferably said substrate is a wood fiber board or a particle board.

40. The method according to claim 39, wherein to form said plate-shaped or beam-shaped pieces, said additional layer is at least partially removed.

41. The method according to claim 28, wherein the end-of-life panels or boards are pressed such that the plate-shaped or beam-shaped pieces have a thickness which lies in a thickness range that spans at most 1 mm, preferably at most 0.5 mm.

42. The method according to claim 28, wherein the plate-shaped or beam-shaped pieces are arranged in the panels in their original orientation, being the orientation they had in the end-of-life panels or boards, or
wherein the plate-shaped or beam-shaped pieces are arranged in the panels upside down.

43. The method according to claim 28, wherein the end-of-life panels are floor panels, and
wherein said panels are floor panels,
wherein the layer-shaped substrate of a said panel comprises at least one layer which consists of one plate-shaped piece obtained from one end-of-life panel, or a part of said one plate-shaped piece.

44. A method for the production of panels, wherein said panels at least comprise a layer-shaped substrate, a top layer, such as a decorative layer or a balancing layer, and an intermediate layer between said layer-shaped substrate and said top layer, wherein the method comprises the steps of:
providing end-of-life panels or boards;
comminuting said end-of-life panels or boards into particles;
wherein said particles are supplied to form said intermediate layer and form at least 50 weight percentage of the intermediate layer.

45. The method as in claim 44, wherein the end-of-life panels or boards comprise thermoplastic material and wherein to form said panels, at least a substrate layer is formed, said particles are strewn upon said substrate layer and are subjected to heat,
wherein said substrate layer forms the layer-shaped substrate of a said panel and said strewn particles at least partly form the said intermediate layer of the panel.

46. A panel, for example a floor panel or a wall panel or a furniture panel,
wherein said panel comprises at least a layer-shaped substrate,
wherein said layer-shaped substrate comprises recycled material from end-of-life panels or boards,
wherein said recycled material comprises plate-shaped or beam-shaped pieces,
wherein said pieces are obtained by subjecting said end-of-life panels or boards to one or more of the following shaping steps: cutting, sawing, milling, pressing, performing surface treatments such as shaving, peeling or sanding, or delaminating.

47. The panel according to claim 46, wherein the layer-shaped substrate comprises:
one said piece or a part of one said piece; or
two or more of said pieces and/or parts of two or more of said pieces, which lie next to each to each other according to the plane of the panel,
wherein said pieces form at least half of the thickness of the layer-shaped substrate.
